(19) United States
(12) Patent Application Publication
(10) Pub. No.: US 2002/0196297 A1
(43) Pub. Date: Dec. 26, 2002

(54) Electrostatic window sticker print medium and methods of making and using same

(76) Inventor: Chad A. Stevens, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/888,215

(22) Filed: Jun. 21, 2001

(51) Int. Cl. B41J 3/00

(52) U.S. Cl. 347/4

(57) ABSTRACT

A print medium that can serve as an electrostatic sticker is provided. A user generates any desired image including text and/or graphics using the software packages available to host computer systems. The image is then printed on the print medium using a printer connected to the host computer system, preferably an inkjet printer. Consequently, any user with a printer and host computer can easily and without great expense design and print a custom electrostatic sticker.

### FIELD OF THE INVENTION

The present invention relates to the field of electrostatic window stickers that are used for advertising, decoration or expression. More particularly, the present invention provides an electrostatic window sticker print medium that can be printed on so as to economically produce customized window stickers.

### BACKGROUND OF THE INVENTION

Electrostatic stickers are widely used for a variety of purposes. These stickers are often applied to a window in an automobile or building, but may also be adhered to other surfaces such as on appliances, cathode ray tubes, etc. Electrostatic stickers may be applied for decoration, advertising, giving product information or simply to express a thought. Additionally, in automobiles, electrostatic stickers may be used, for example, to advertise a business to which the vehicle belongs, evidence parking privileges or indicate the mileage at which the next oil change for the vehicle should be made.

Electrostatic stickers adhere to a window or other surface using a static electric charge. The sticker is typically made of a non-conductive flexible material such as vinyl. Because the material is non-conductive, a static electric charge can be deposited on one side of the sticker and will remain distributed over the surface of the sticker. This charge is typically protected from being dissipated before the sticker is applied by a backing or protective layer that can be pealed from the sticker when the sticker is to be placed. The backing is typically a waxed paper layer.

Electrostatic stickers adhere to windows and other surfaces by electrically interacting with the molecules of the window or surface to which the sticker is applied. In the example of a sticker adhered to a window, the electrostatic charge on the sticker will repel like charged elements in the glass of the window, leaving a slightly opposite charge on the surface of the window. The attractive force between this slight opposite charge and the electrostatic charge on the sticker will keep the sticker in place on the window.

While electrostatic stickers have such wide applications, they can be relatively expensive to procure. If the person or business wanting the electrostatic sticker wants the sticker to display a common graphic or message, it may be possible to purchase a suitable sticker from a vendor. However, if the business or person wanting the sticker wants the sticker to contain specific information, such as a trademark, advertising message, phone and address information for the owner, etc., the sticker must be custom made with the required graphics or text.

Obviously, having such stickers custom-made may entail a considerable expense. A sticker, printing or signage company must be identified with the equipment to produce such stickers. The sticker must then be designed and produced by the vendor. The price for this is likely to be relatively high unless the customer happens to be a significant business ordering a large number of stickers.

Consequently, there is a need in the art for a means of producing customized electrostatic stickers in a quick and cost-efficient manner.

### SUMMARY OF THE INVENTION

The present invention meets the above-described needs and others. Specifically, the present invention provides a system and method for producing customized electrostatic stickers in a quick and cost-efficient manner.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as a system for producing user-customized electrostatic stickers. The system includes a host computer for generating a user-selected image; a printer connected to the host computer for receiving print data corresponding to the user-selected image; and a sticker print medium on which the user-selected image is printed with the printer to produce the user-customized sticker. The print medium includes an electrostatic charge that allows the medium to be adhered to a surface as an electrostatic sticker. Preferably, the printer is an inkjet printer.

The present invention also encompasses, or can be phrased as, a method of making a user-customized electrostatic sticker by printing a user-selected image on sticker print medium, the sticker print medium being of a non-conductive material on which an electrostatic charge can be maintained such that the sticker print medium functions as an electrostatic sticker.

The method may also include reversing the user-selected image before printing the user-selected image on the sticker print medium. This allows the sticker to be used on the interior of a window and viewed correctly through the window. Reversing the user-selected image may be performed with the print driver of the host computer. Alternatively, reversing the user-selected image may be performed with the firmware of the printer that prints the user-selected image.

The method may also include providing an electrostatic charge on the sticker print medium prior to the printing of the user-selected image. Alternatively, the method may be performed by depositing an electrostatic charge on the sticker print medium with a charge donor after the printing of the user-selected image.

Where the electrostatic charge is provided prior to printing, the method preferably includes protecting the electrostatic charge with a protective backing. Then, after printing, the method includes removing the protective backing and applying the sticker. Preferably, the method of applying the sticker includes applying the electrostatic sticker such that a side of the sticker bearing the electrostatic charge is in contact with the surface to which the sticker is applied.

Preferably, the method of the present invention also includes perforating one or more sections of the sticker print medium. In this way, a number of stickers can be printed on and obtained from a single sheet of sticker print medium in various shapes and sizes.

The present invention also encompasses the electrostatic sticker print medium per se. Specifically, the present invention encompasses an electrostatic sticker print medium for use with a printer, the sticker print medium including a blank sheet of electrostatic print medium; an electrostatic charge deposited on a side of the sticker print medium; and a protective backing over the electrostatic charge.

Alternatively, the present invention may be embodied as an electrostatic sticker kit including at least one sheet of electrostatic sticker print medium; and a charge donor for depositing an electrostatic charge on either side of the sticker print medium.

In either case, the sticker print medium is preferably made of vinyl. The electrostatic print medium may also be transparent. The medium may also be perforated to define a plurality of sticker panes within a single sheet of print medium.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is an illustration of a system for producing user-customized electrostatic stickers according to the present invention.

FIG. 2 is an illustration of a second embodiment of the system for producing usercustomized electrostatic stickers of the present invention.

FIG. 3 is an illustration of a third embodiment of the system for producing usercustomized electrostatic stickers of the present invention.

FIG. 4 is an illustration of a fourth embodiment of the system for producing usercustomized electrostatic stickers of FIG. 1.

FIG. 5 is an illustration of a fifth embodiment of the system for producing usercustomized electrostatic stickers of FIG. 1.

FIG. 6 is an illustration of various embodiments of the electrostatic sticker printing medium of the present invention.

Throughout the drawings, identical elements are designated by identical reference numbers.

### DETAILED DESCRIPTION OF THE PREFERRED EMBODIMENTS

Stated in broad general principle, the present invention provides a print medium which can serve as an electrostatic sticker and which can be printed on using a printer. Consequently, any user with a printer and host computer can easily and without great expense design and print a custom electrostatic sticker.

As used herein, the term “electrostatic sticker” refers to a printed sticker that is adhered to a window or other target surface by supplying an electrostatic charge on at least one side of the sticker. Electrostatic stickers adhere to windows and other surfaces by electrically interacting with the molecules of the window or surface to which the sticker is adhered. Specifically, the electrostatic charge on the sticker will repel like charged elements in the surface to which it is applied, leaving a slightly opposite charge on that surface. The attractive force between this slight opposite charge and the electrostatic charge on the sticker will keep the sticker in place.

Electrostatic stickers typically do not have or need any form of chemical adhesive with which to apply the sticker. However, including such an additional chemical adhesive in addition to an electrostatic charge is not precluded as a possibility and would be within the scope of the present invention.

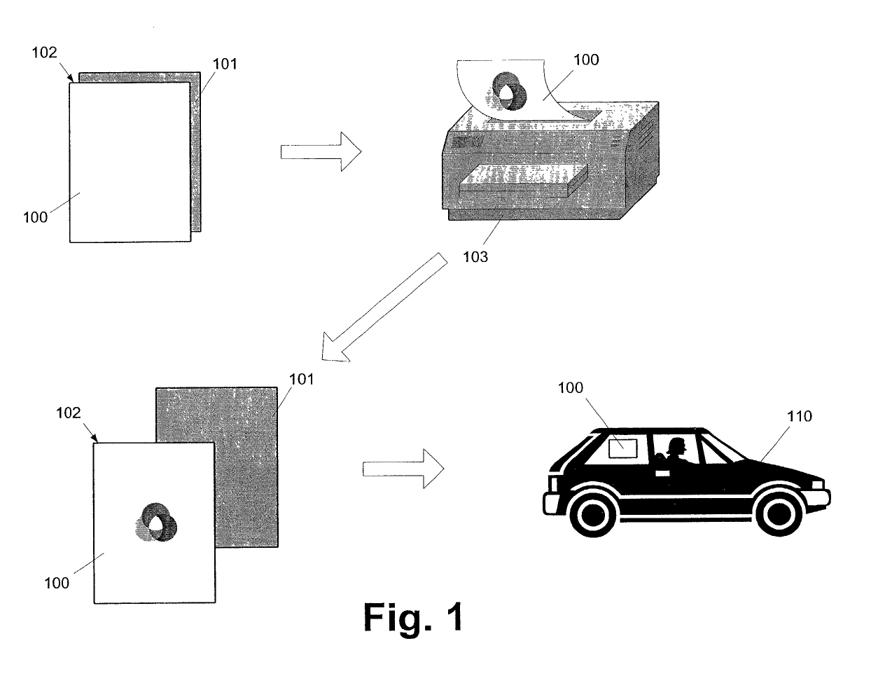

Using the drawings, the preferred embodiments of the present invention will now be explained. FIG. 1 is an illustration of a system for producing user-customized electrostatic stickers according to the present invention.

As shown in FIG. 1, the present invention includes a novel print medium (100) which can be printed on using a printer. The print medium (100) is also designed to serve as an electrostatic sticker after it has been printed on. Throughout this specification, element (100) of the figures will be variously referred to as a sticker, sticker medium, print medium, etc. It will be understood that element (100) is all of these, a sticker or print medium and a sticker after printing. Physically, the print medium (100) is a non-conductive material on which an electrostatic charge can be distributed and where such a charge will remain.

In FIG. 1, an electrostatic charge (102) has been applied to the rear side (as illustrated) of the print medium (100). A protective backing (101) is placed over the side of the medium (100) that includes the electrostatic charge. This backing (101) prevents the charge (102) from being inadvertently dissipated during the storage and printing of the medium (100).

Absent the backing (101), the charge (102) would be dissipated whenever any conductive object came into contact with the charge (102). Such conductive objects could include a user's hands and ambient water vapor.

The backing (101) is preferably a waxed paper. However, other sheet materials can also serve as the backing (101). The backing (101) need only adhere to the sticker medium (100) without depleting and while protecting the electrostatic charge (102). When the sticker is finished and ready to be applied, the backing (101) is typically pealed or pulled from the sticker. However, as will be explained below, such is not always the case.

A preferred material for making the print medium (100) is vinyl. Ideally, the print medium (100) is light weight so that the weight of the material does not tend, over time, to defeat the electrostatic hold of the charge (102) and displace the sticker. Additionally, the sticker medium (100) may be preferably transparent so that a viewer's focus is entirely on the printing on the sticker (100).

As shown in FIG. 1, the print medium (100) can be run through a printer (103). With the printer (103), a user can print any graphics or text that he or she can generate as an electrostatic sticker. This provides the cost-effective flexibility to produce electrostatic stickers that the art has previously lacked.

The printer (103) in the embodiment of FIG. 1 is preferably an inkjet printer. Inkjet printers typically provide superior printing on vinyl and other such media that would be preferred for use as an electrostatic sticker.

In the particular embodiment illustrated in FIG. 1, the text and/or graphics of the sticker are printed directly on the sticker medium (100) on the side opposite the backing (101) and electrostatic charge (102). The finished sticker then emerges from the printer (103) and can then be applied to the target surface.

When the sticker (100) is applied, it is preferable that the electrostatic charge (102) be sandwiched between the sticker (100) and the surface to which the sticker is applied. This protects the charge (102) from dissipation and consequently promotes the longevity of the sticker (100).

FIG. 1 illustrates, by way of example, the placing of the sticker (100) on the window of an automobile (110). In this embodiment, in order to sandwich the charge (102) between the sticker (100) and the surface to which it is applied, e.g., the car window, the sticker (100) would preferably by placed on the outside of the car window so as to position the side of the sticker (100) bearing the charge (102) directly against the glass of the window.

Because the sticker (100) would then be exposed to the elements in the foregoing example, this particular embodiment of the present invention may be preferred for applications other than printing electrostatic stickers for car and other exterior windows. For example, the present embodiment of the present invention would be preferred for printing stickers for interior windows, appliances and other products where the sticker is not likely to be in the elements. Additionally, the print medium (100) in this example need not be transparent but can be any color or design desired by the user.

Alternatively, a sticker (100) printed by the embodiment illustrated in FIG. 1 could still be applied to the interior of a window, e.g. a car window, and viewed through that window. This is done as follows. It is possible that the charge (102) on the sticker can be made strong enough to hold the sticker (100) to the window or other surface even if the charge (102) is on the opposite side of the sticker (100) from the surface to which the sticker is applied. In this case, it may be preferred to leave the backing (101) on the sticker (100) to prevent the charge (102) from dissipation.

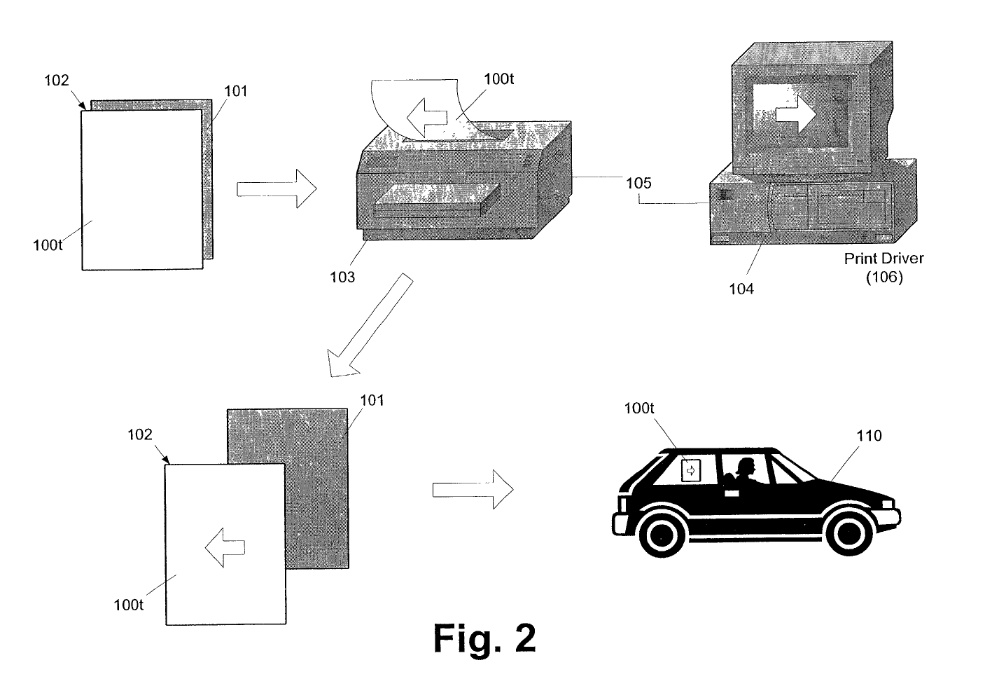

FIG. 2 illustrates a second preferred embodiment of the present invention. The embodiment of FIG. 2 is a preferred embodiment for producing electrostatic stickers that are to be applied to and viewed through a window, e.g., a car window.

As shown in FIG. 2, the print medium (100t) includes the charge (102) and protective backing (101) described above. However, the medium (100t) is now preferably transparent for reasons that will be described below.

As before, the sticker medium (100t) is run through a printer (103), preferably an inkjet printer, and the image desired for the sticker is printed thereon. This image is typically generated using a host computer (104) connected directly or through a network (105) to the printer (103).

The host computer (104) may be using any word processing, graphic design, or other software package to generate the image that will be printed on the sticker (100t). Additionally, the host computer (104) will also be executing a printer driver (106). The printer driver (106) is the software package that interfaces the computer (104) with the printer (103). The printer driver (106) translates the image generated on the computer (104) into data the printer (103) can receive and use to print the sticker (100t).

In the present example, the image on the sticker is ultimately going to be viewed through a window and through the medium (100t) on which it is printed. In other words, the image is going to be viewed from behind. Consequently, for the image to appear correctly when viewed as intended, through the window to which it is applied and through the medium (100t) on which it is printed, it is necessary for the image to be printed in reverse. The charge on the sticker is preferably placed on the side opposite the printing and is then sandwiched between the sticker and the surface to which the sticker is applied.

The printer driver (106) can include a routine for reversing the image produced on the computer (104) before the image data is sent to the printer (103) for printing. The user interface of the printer driver (106) will preferably have an option that allows the user to specify that this type of print medium (100t) is being printed and that the image needs to be reversed as printed. Consequently, as shown in FIG. 2, the image as printed by the printer (103) is reversed from the image generated on the computer (104).

When the printing is completed, the backing (101) is removed from the sticker medium (100t). The side of the medium (100t) bearing the charge (102) is then applied to the interior of a window, e.g. a car window as shown in FIG. 2. Consequently, the charge (102) is sandwiched between the surface to which it is applied, a window, and the sticker (loot). As indicated above, this is preferred to promote the longevity of the sticker (100t).

The printing on the sticker (100t) is then intended for viewing from outside the car, through the car window and through the sticker medium (100t). From this viewpoint, the reverse-printed image appears correctly to the viewer as illustrated in FIG. 2.

The sticker (100t) of this embodiment could also be applied to the interior of a window in a building or room. In any of these examples, the sticker (100t) is kept inside the automobile or building and is consequently out of the elements and has an increased longevity.

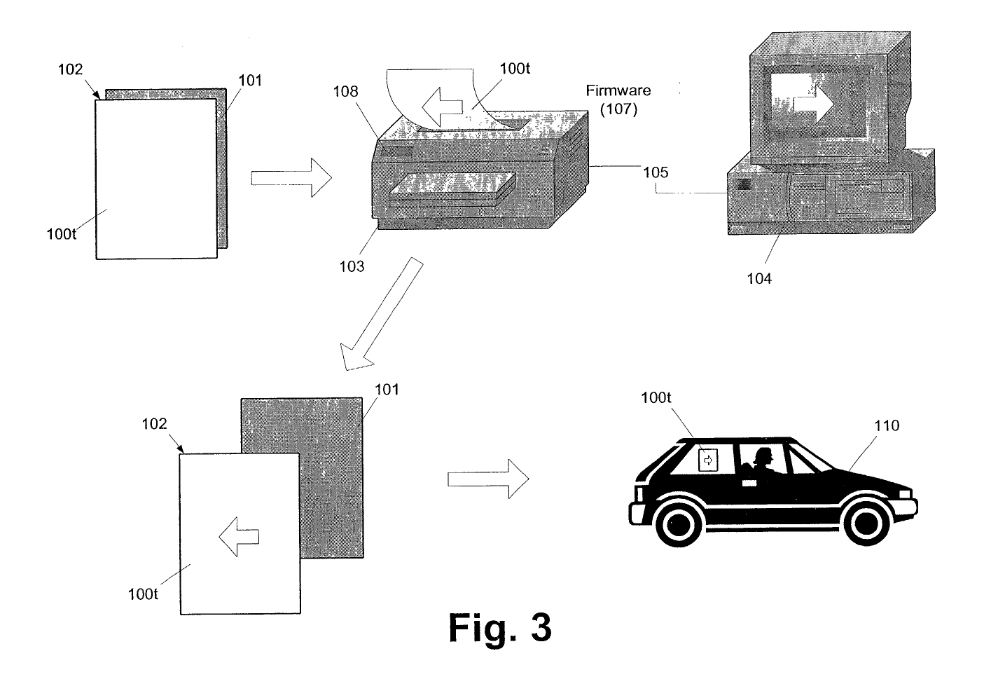

FIG. 3 illustrates a third embodiment of the present invention which is very similar to the second embodiment illustrated in FIG. 2. However, in FIG. 3, the computer (104) does not include a print driver that reverses the image to be printed on the sticker (100t). Rather, the image is sent to the printer (103) in the normal fashion.

The print data is received in the printer (103) and processed by the printer's firmware (107). The firmware (107) is a combination of software and hardware that control the operation of the printer (103).

In the present example, the firmware (107) of the printer (103) can be designed to reverse the image being printed for the sticker (100t). A user interface (108) on the printer, e.g. a keypad and display device, can be used to instruct the printer (103) that an electrostatic sticker (100t) is being printed and that the image received from the computer (104) must be reversed before printing.

The firmware (107) then executes an appropriate routine to reverse the image as specified in the print data from the computer (104). The image is then printed in reverse on the sticker medium (100t) as shown in FIG. 3.

The remainder of the example is identical to that described above in connection with FIG. 2. The backing (101) is removed from the sticker medium (100t) and the sticker (100t) is applied to the interior of a car or building window for viewing from the opposite side of that window.

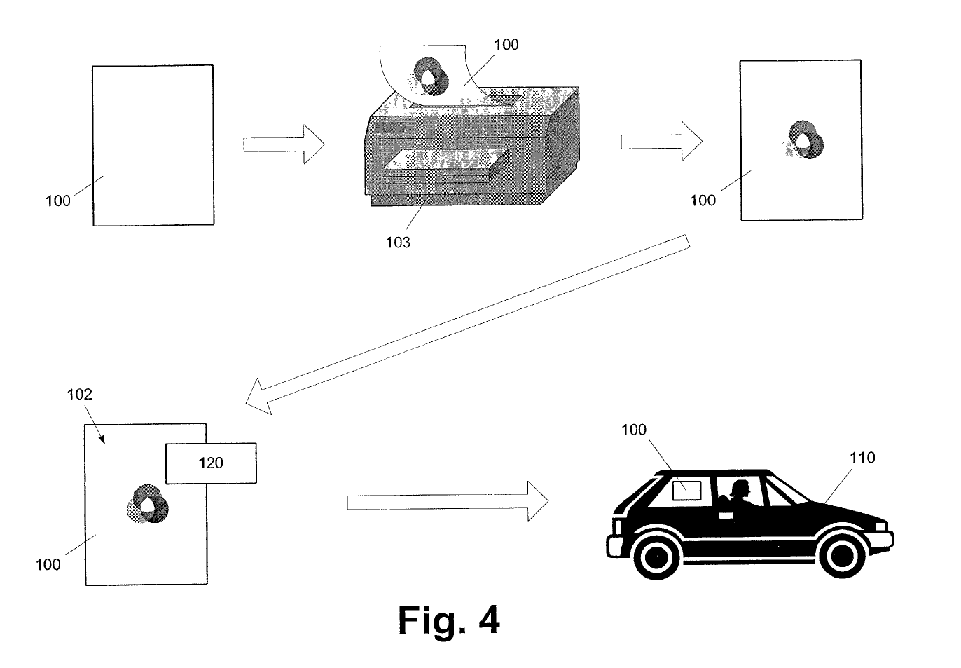

FIG. 4 illustrates a fourth embodiment of the present invention. In this embodiment, the electrostatic charge and protective backing are not provided on the sticker medium (100) when supplied to the user. Rather, the charge is applied by the user after printing has been completed.

As shown in FIG. 4, the sticker medium (100) is run through the printer (103) and the sticker image is printed thereon. The medium (100) can be transparent, but is not required to be so.

After the sticker is printed, a charge donor (120) is used to apply an electrostatic charge (102) to either side of the sticker (100). The charge donor (120) is a piece of material that, when rubbed against or brought into contact with the sticker medium, deposits a charge on the sticker medium (100). For example, the charge donor (120) can be wool, a white-board eraser, or the like. A wide variety of acceptable charge donors (120) will be readily apparent to those skilled in the art.

The charge (102) can be applied to either side of the sticker (101) with the charge donor (120). Consequently, the charge can be applied on the same surface as the printed image, if the image is to be viewed through the surface, e.g., a window, to which the sticker is applied. Alternatively, if the back of the sticker (the side opposite the printed image) is to be in contact with the surface to which the sticker is applied, the charge can be placed on the back of the sticker. In either case, the sticker medium (100) need not be transparent.

In the preceding examples, the printer (103) used to print on the sticker medium (100) has been preferably an inkjet or non-laser printer. The present invention can be practiced with a laser printer, however several complications arise. Specifically, the toner deposited by a laser printer is typically heat-fused to the print medium with a fuser. The heat of the fuser tends to melt the type of materials, e.g., plastics and vinyl, that are best suited as electrostatic sticker media. Consequently, the sticker media (100) must be made thick enough or of a material that will not be melted by the fuser in the laser printer.

Additionally, a laser printer operates by depositing selective charge patterns on the medium being printed. This charge pattern then attracts a corresponding toner pattern. Consequently, it is possible that any electrostatic charge applied to the print medium (100) before printing will interfere with the printing process.

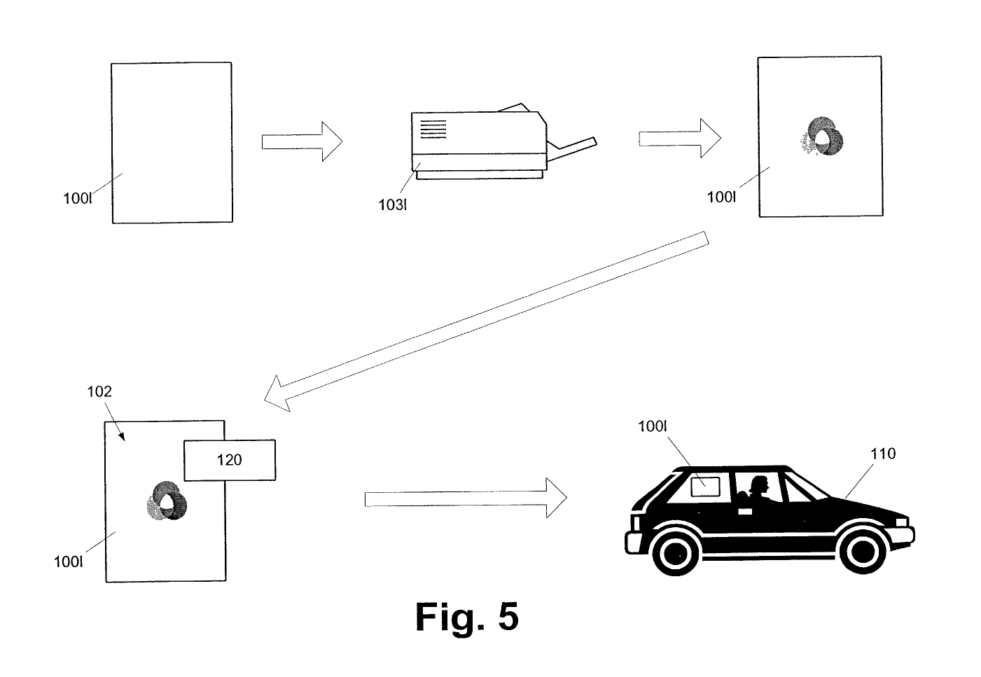

To overcome these problems, the present invention is preferably implemented with a laser printer (1031) as shown in FIG. 5. Uncharged sticker media (1001) is run through the laser printer (1031) and printed with the desired sticker image. The sticker media (1001) must be constructed to withstand the temperatures imposed by the printer's fuser.

An electrostatic charge is then applied to the printed sticker (1001) using a charge donor (120). This is done in the same way as described above in connection with FIG. 4. The charge can be applied to either side of the sticker depending on the intended use of the sticker. The sticker is then applied, preferably with the electrostatic charge sandwiched between the sticker and the surface to which the sticker is applied. The sticker medium (1001) may, but need not be, transparent.

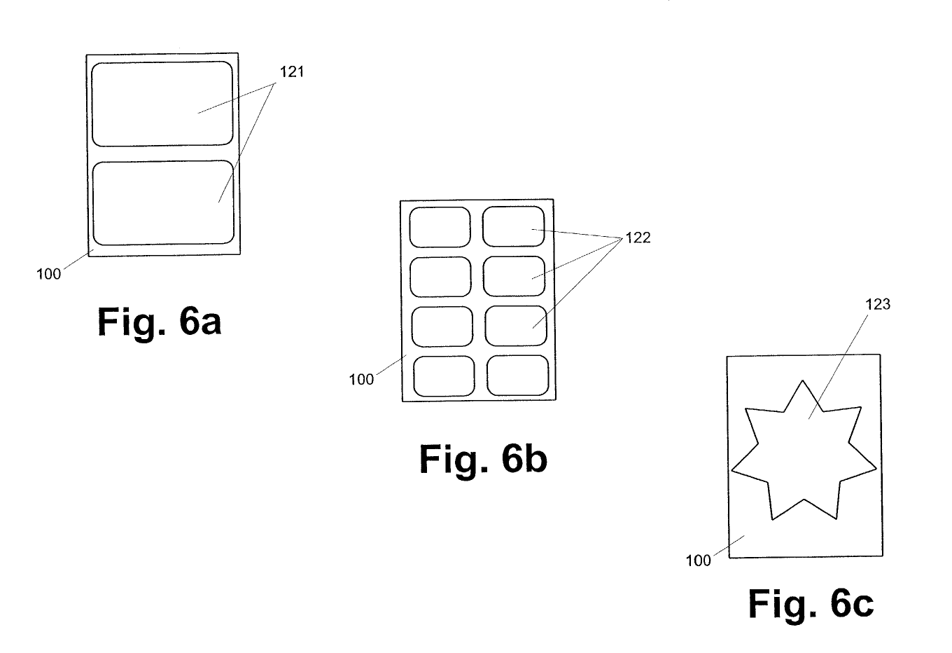

FIGS. 6a-6c illustrates various embodiments of the sticker medium (100) according to the present invention. In the preceding examples, each sticker has consisted of an entire sheet of print medium. However, the present invention is not so restricted. Rather, as shown in FIG. 6a, the present invention includes, for example, a sheet of print medium perforated to provide two sticker panes (121). Additionally, as shown in FIG. 6b, the present invention includes, for example, a sheet of print medium perforated to provide multiple electrostatic sticker panes (122). Finally, as shown in FIG. 6c, the present invention includes, for example, a sheet of print medium perforated to provide an electrostatic sticker pane (123) that is in a desired, non-rectangular shape.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of making a user-customized electrostatic sticker, said method comprising printing a user-selected image on sticker print medium, said sticker print medium being of a non-conductive material on which an electrostatic charge can be maintained such that said sticker print medium functions as an electrostatic sticker.

2. The method of claim 1, further comprising reversing said user-selected image before said printing said user-selected image on said sticker print medium.

3. The method of claim 2, further comprising reversing said user-selected image with a print driver of a host computer.

4. The method of claim 2, further comprising reversing said user-selected image with firmware of a printer which performs said printing of said user-selected image.

5. The method of claim 1, further comprising providing an electrostatic charge on said sticker print medium prior to said printing of said user-selected image.

6. The method of claim 5, further comprising protecting said electrostatic charge with a protective backing.

7. The method of claim 6, further comprising removing said protective backing and applying said sticker.

8. The method of claim 1, further comprising depositing an electrostatic charge on said sticker print medium with a charge donor after said printing of said user-selected image.

9. The method of claim 1, further comprising perforating one or more sections of said sticker print medium.

10. The method of claim 5, further comprising applying said electrostatic sticker such that a side of said sticker bearing said electrostatic charge is in contact with a surface to which said sticker is applied.

11. The method of claim 8, further comprising applying said electrostatic sticker such that a side of said sticker bearing said electrostatic charge is in contact with a surface to which said sticker is applied.

12. An electrostatic sticker print medium for use with a printer, said sticker print medium comprising:
a blank sheet of electrostatic print medium;
an electrostatic charge deposited on a side of said sticker print medium; and
a protective backing over said electrostatic charge.

13. The sticker print medium of claim 12, wherein said sticker print medium is made of vinyl.

14. The sticker print medium of claim 12, wherein said sheet of electrostatic print medium is transparent.

15. The sticker print medium of claim 12, wherein said sheet of electrostatic print medium is perforated to define a plurality of sticker panes.

16. An electrostatic sticker kit comprising:
at least one sheet of electrostatic sticker print medium; and
a charge donor for depositing an electrostatic charge on either side of said sticker print medium.

17. The sticker print medium of claim 16, wherein said sticker print medium is made of vinyl.

18. The sticker print medium of claim 16, wherein said sheet of electrostatic print medium is transparent.

19. The sticker print medium of claim 16, wherein said sheet of electrostatic print medium is perforated to define a plurality of sticker panes.

20. A system for producing user-customized electrostatic stickers, said system comprising:
a host computer for generating a user-selected image;
a printer connected to said host computer for receiving print data corresponding to said user-selected image; and
a sticker print medium, comprising an electrostatic charge, on which said userselected selected image is printed with said printer to produce said user-customized sticker.

21. The system of claim 20, wherein said printer is an inkjet printer.
